(19) United States
(12) Patent Application Publication
(10) Pub. No.: US 2026/0262587 A1
(43) Pub. Date: Sep. 10, 2026

(54) METHOD AND SYSTEM FOR CONTROLLING PIVOT IRRIGATION SYSTEM BASED ON ELECTRICAL CURRENT DRAW PROFILE

(71) Applicant: Lindsay Corporation, Omaha, NE (US)

(72) Inventors: Reece Robert Andrews, Omaha, NE (US); Mark William Miller, Omaha, NE (US); Rick Provaznik, Omaha, NE (US)

(21) Appl. No.: 19/072,410

(22) Filed: Mar. 6, 2025

(51) Int. Cl. A01G 25/16; A01G 25/09

(52) U.S. Cl. CPC A01G 25/16; A01G 25/092

(57) ABSTRACT

A computer-implemented method of controlling operations of a center pivot irrigation system includes receiving, via a controller, a first measurement of an electrical characteristic related to a current total electrical power usage of the irrigation system during an active portion of a first duty cycle of a command signal directed to an end tower of the irrigation system; receiving, via the controller, a second measurement related to a current total electrical power usage of the irrigation system during an inactive portion of the duty cycle of the command signal; calculating, via the controller, a difference between the first measurement and the second measurement; determining, via the controller, whether the difference is below a first predefined threshold; and sending, via the controller, an instruction to disconnect power from the end tower of the center pivot irrigation system if the difference is below the first predefined threshold.

### BACKGROUND

A pivot irrigation machine is controlled by providing instructions to the radially outermost tower relative to a central pivot. The inner towers passively respond to the outermost tower by moving when they become out of alignment with their respective outboard span. In other words, the last tower sets the machine pace and also causes the rest of the machine to move. If the last tower stops moving for any reason the entire machine will stop moving. Therefore, determining and monitoring the state of the last tower is important to determining how well the pivot irrigation machine is moving through a field.

However, it is difficult to determine whether the last tower is moving when commanded to move. There is no feedback to the central controller that the last tower is in fact moving when commanded to move.

One current solution for attempting to determine the movements of the last tower includes using an overwatering timer. The overwatering timer monitors a command voltage applied to the next-to-last tower contactor. If the next-to-last tower contactor has not been energized, this tends to indicate that the last tower is not moving because it is stuck or the drive train is no longer effective at moving the last tower. This could be caused by a number of reasons, including a flat tire, the tower being stuck in mud or rut, a broken wire to electric drive motor, a broken drive shaft from drive motor to drive gearboxes, an electric drive motor that is no longer operational, etc. If no energy has been applied to next-to-last tower contactor command input within a user set time period (usually between 10-20 minutes), the overwatering timer opens up a safety circuit. When the safety circuit is opened, the power (generally 120 volts alternating current (VAC)) on that line does not reach the main control panel at the pivot point. With the loss of this power, the main control panel stops the irrigation machine by opening the 3-phase reversing contactor in the main control panel, and if equipped, commands a pump to stop pumping.

However, monitoring the command voltage applied to the next-to-last tower contactor is a lagging indicator of the commanded movement of the machine, as the time period selected to expire before triggering the safety circuit does not change as a function of duty cycle and ground speed of the pivot. Therefore, this time period has to be set conservatively large to accommodate the slowest ground speeds and is typically set to 10 minutes or more, which means that the pivot could be sitting and watering in place for that full time period before the overwatering timer times out and opens the safety signal line. Additionally, the overwatering timer is one more distributed device located on the irrigation machine that could fail, and the operator would not know the current state of the overwatering timer without in-person inspection.

Another solution for attempting to determine the movements of the last tower involves the central controller. The central controller is configured to monitor a pivot angle. The pivot angle is measured with either an encoder at the central pivot point measuring the angle of the first span, or by receiving a position of a portion of the machine from a global navigation satellite system (GNSS) receiver positioned on the machine (preferably on the last tower). The GNSS receiver provides the latitude and longitude of the receiver which is used to calculate the pivot angle of the irrigation machine. If the measured pivot angle has not changed a predefined amount in a predefined amount of time, then the last tower is assumed to be stopped (even though the last tower is commanded to move). Upon this determination, the main control panel stops the irrigation machine by opening the 3-phase reversing contactor in the main control panel, and if equipped, commands the pump to stop pumping.

However, measuring pivot angle is also a lagging indicator of the commanded movement of the machine. Particularly at slow ground speeds where it can take quite some time to monitor the movement of the machine based on pivot angle, the end tower may be stuck/moving for a while before the controller is able to accurately infer the status of the last tower. This can also be exacerbated by a GNSS receiver with low accuracy. As with monitoring the command voltage applied to the next-to-last tower contactor, this solution monitors pivot movement (generally defined as 1 degree of rotation) achieved within an amount of time set by the user. Thus, this time generally must be set to accommodate for the slowest movement expected and is therefore very slow at determining the end tower is at a standstill.

The background discussion is intended to provide information related to the present invention which is not necessarily prior art.

### SUMMARY

The present invention solves the above-described problems and other problems by providing systems and methods of controlling operations of a pivot irrigation system that greatly reduce the number of sensors required to collect data in a field.

A computer-implemented method of controlling operations of a center pivot irrigation system according to an embodiment of the present invention includes receiving, via one or more processor of a controller of the center pivot irrigation system, a first signal representative of a first measurement of an electrical characteristic related to a current total electrical power usage of the center pivot irrigation system during an active portion of a first duty cycle of a command signal directed to an end tower of the center pivot irrigation system; receiving, via the one or more processor, a second signal representative of a second measurement of an electrical characteristic related to a current total electrical power usage of the center pivot irrigation system during an inactive portion of the duty cycle of the command signal; calculating, via the one or more processor, a difference between the first measurement and the second measurement; determining, via the one or more processor, whether the difference is below a first predefined threshold; and sending, via the one or more processor, a signal representative of an instruction to disconnect power from the end tower of the center pivot irrigation system if the difference is below the first predefined threshold.

The computer-implemented method according to this embodiment derives information about the functioning of the end tower from the total electrical power usage, which is a more responsive than relying on the lagging indicators of command voltage applied to the next-to-last tower contactor and pivot angle.

Another embodiment of the invention is a center pivot irrigation system that includes mobile support towers, a fluid-carrying conduit supported above the field by the mobile towers, fluid emitters coupled with the fluid-carrying conduit, a pump for directing flow of fluids through the fluid emitters, and a processor. The mobile support towers are configured to move across a field about a central pivot point and include a radially outmost mobile support tower having an end motor and inner mobile support towers located radially inward from the outmost mobile support tower. The inner mobile support towers have inner motors for propulsion. The processor is in communication with the end motor, the inner motors, and the pump. The processor is configured to transmit a command signal having a duty cycle with an active portion and an inactive portion to the end motor; receive a first signal representative of a first measurement of an electrical characteristic related to a current total electrical power usage of the end motor, the inner motors, and the pump during the active portion of the duty cycle of the command signal; receive a second signal representative of a second measurement of an electrical characteristic related to a current total electrical power usage during the inactive portion of the duty cycle of the command signal; calculate a difference between the first measurement and the second measurement; determine whether the difference is below a first predefined threshold; and send a signal representative of an instruction to disconnect power from the end motor if the difference is below the first predefined threshold.

Another embodiment of the invention is a controller for controlling operations of a center pivot irrigation system in a field having mobile support towers configured to move across the field about a central pivot point. The mobile support towers include a radially outmost mobile support tower having an end motor and inner mobile support towers located radially inward from the radially outmost mobile support tower and having inner motors. The controller includes a safety circuit, a sensor, and a processor. The safety circuit is configured to disconnect electric power to the center pivot irrigation system. The sensor is configured to detect a total current amperage of the center pivot irrigation system. The processor is in communication with the safety circuit and the sensor and is configured to transmit a command signal having a duty cycle with an active portion and an inactive portion to the end motor of the center pivot irrigation system; receive from the sensor a first signal representative of a first measurement of the total current amperage of the center pivot irrigation system during the active portion of the duty cycle of the command signal; receive from the sensor a second signal representative of a second measurement of the total current amperage of the center pivot irrigation system during the inactive portion of the duty cycle of the command signal; calculate a difference between the first measurement and the second measurement; determine whether the difference is below a first predefined threshold; send to the safety circuit a signal representative of an instruction to disconnect power to the center pivot irrigation system if the difference is below the first predefined threshold; determine whether the second measurement is below a second predefined threshold; receive from the sensor an additional signal representative of an additional measurement of the total current amperage of the center pivot irrigation system during an inactive portion of one or more additional consecutive duty cycle of the command signal; and send to the safety circuit a signal representative of an instruction to disconnect power to the center pivot irrigation system if the additional measurement is below the second predefined threshold.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE DRAWING FIGURES

Embodiments of the present invention are described in detail below with reference to the attached drawing figures, wherein:

FIG. 1 is a perspective view of an exemplary irrigation system in which principles of the present invention may be implemented;

FIG. 2 is a block diagram depicting selected components of the irrigation system of FIG. 1; and

FIG. 3 is a flowchart depicting exemplary steps of a method according to an embodiment of the present invention.

The drawing figures do not limit the present invention to the specific embodiments disclosed and described herein. The drawings are not necessarily to scale, emphasis instead being placed upon clearly illustrating the principles of the invention.

### DETAILED DESCRIPTION OF THE EMBODIMENTS

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

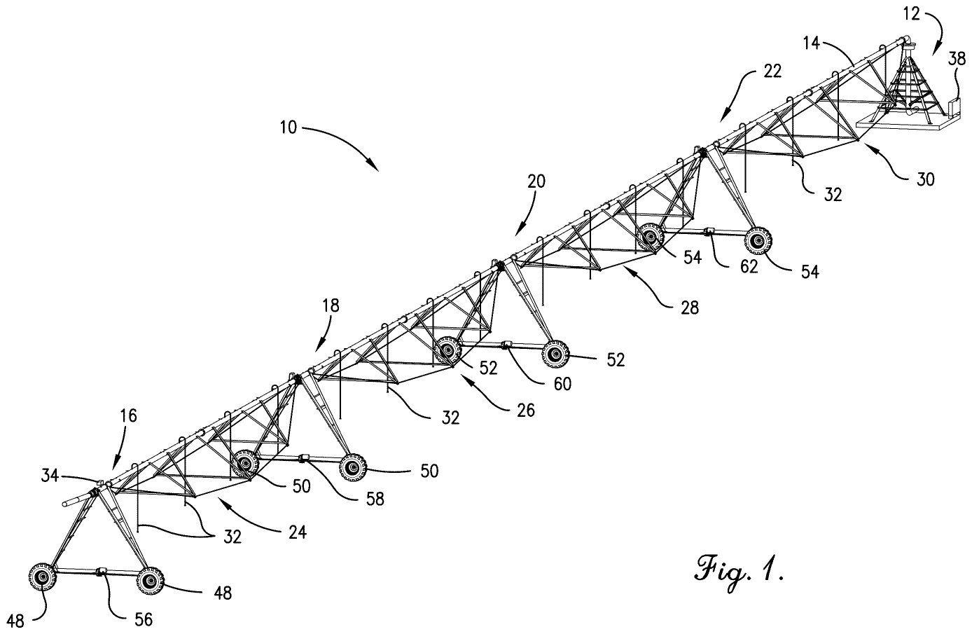

Turning to FIG. 1, an irrigation system 10 constructed in accordance with an embodiment of the invention is illustrated. The irrigation system 10 may have access to a hydrant, well, water tank, or other source 12 of water and may also be in fluid communication with a tank or other source of agricultural products to inject fertilizers, pesticides and/or other chemicals into the water for application during irrigation.

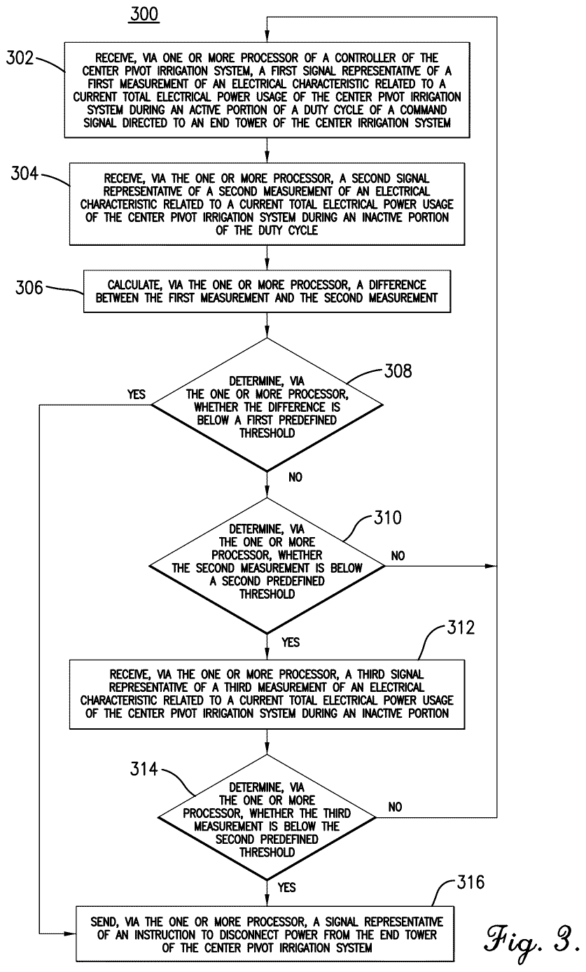

The irrigation system 10 may comprise a number of spaced-apart mobile towers 16, 18, 20, 22, a fluid-distribution conduit 14 in fluid communication with the water source 12 and supported by the towers 16, 18, 20, 22 above a field, a plurality of truss sections 24, 26, 28, 30 or other supports to form a number of interconnected spans that help support the conduit 14, a plurality of fluid emitters 32 that are in fluid communication with the conduit 14, one or more pumps 34 for controlling flow of fluids to the emitters 32, one or more sensors 36 (depicted in FIG. 3) for capturing data about an electrical characteristic related to a current total electrical power usage, and a control system 38 for controlling operation of the irrigation system 10.

The mobile towers 16, 18, 20, 22 support the conduit 14 and carry the conduit 14 and emitters 32 across the field. Each mobile tower 16, 18, 20, 22, includes a frame 40, 42, 44, 46 for supporting a portion of the conduit 14 and wheels 48, 50, 52, 54 rotatably attached to the frame 40, 42, 44, 46. One or more of the towers 16, 18, 20, 22 may include a motor 56, 58, 60, 62 for driving the wheels 48, 50, 52, 54 of its respective tower 16, 18, 20, 22.

The conduit 14 spans across the irrigation system 10 and carries water and/or other fluids to the emitters 32. The conduit 14 may comprise piping, one or more hoses, or the like. Water and/or other fluids may travel from the water source 12 to the conduit 14, which directs them to the emitters 32.

The fluid emitters 32 apply the water and/or other fluids transported by the conduit 14 to the crops and/or soil beneath the conduit 14. The fluid emitters 32 are spaced along the truss sections 24, 26, 28, 30 and may include a plurality of sprayer heads, sprinkler drops, spray guns, drop nozzles, valves, and/or other devices. The one or more pumps 34 direct flow of water and/or other fluids through the emitters 32. In one or more embodiments, the pump 34 is located at an end of the irrigation system 10.

The one or more sensors 36 are configured to capture data an electrical characteristic related to a current total electrical power usage. The electrical characteristic may be a current, voltage, phase angle, frequency, or the like. In preferred embodiments, the one or more sensors 36 are configured to measure a total current draw pulled by the irrigation system 10, including current draw from the motors, 56, 58, 60, 62 and the pump 34. The one or more sensors 36 may be configured to measure one or more electrical characteristics of a single phase of three-phase system and/or all three phases. In one or more embodiments, the one or more sensors 36 may be configured to detect a balance of load between the phases. The one or more sensors 36 may comprise a current sensor, such as a current transformer, a shunt resistor, Hall effect sensor, an optical current sensor, or the like. The one or more sensors 36 may also include a voltage sensor, such as a resistive voltage divider, a capacitive voltage divider, a transformer, a Hall effect voltage sensor, an electro-optic voltage sensor, a digital voltmeter, or the like. In one or more embodiments, the one or more sensors 36 includes a phase monitor, a power meter, a load balance, sensor, a ground fault sensor, a harmonic analyzer, or the like.

The control system 38 is configured to control operations of the irrigation system 10. The control system 38 may comprise a communication element 64, a memory element 66, a processing element 68, and one or more safety circuit 70. The communication element 64 may generally allow communication with systems or devices external to the control system 38. The communication element 64 may include signal or data transmitting and receiving circuits, such as antennas, amplifiers, filters, mixers, oscillators, digital signal processors (DSPs), and the like. The communication element 64 may establish communication wirelessly by utilizing RF signals and/or data that comply with communication standards such as cellular 2G, 3G, 4G, 5G, or LTE, WiFi, WiMAX, Bluetooth®, BLE, or combinations thereof. The communication element 64 may be in communication with the processing element 68 and the memory element 66.

The memory element 66 may include data storage components, such as read-only memory (ROM), programmable ROM, erasable programmable ROM, random-access memory (RAM) such as static RAM (SRAM) or dynamic RAM (DRAM), cache memory, hard disks, floppy disks, optical disks, flash memory, thumb drives, universal serial bus (USB) drives, or the like, or combinations thereof. In some embodiments, the memory element 66 may be embedded in, or packaged in the same package as, the processing element 68. The memory element 66 may include, or may constitute, a “computer-readable medium”. The memory element 66 may store the instructions, code, code segments, software, firmware, programs, applications, apps, services, daemons, or the like that are executed by the processing element 68.

The processing element 68 may include one or more processors, microprocessors (single-core and multi-core), microcontrollers, DSPs, field-programmable gate arrays (FPGAs), analog and/or digital application-specific integrated circuits (ASICs), or the like, or combinations thereof. The processing element 68 may generally execute, process, or run instructions, code, code segments, software, firmware, programs, applications, apps, processes, services, daemons, or the like. The processing element 68 may also include hardware components such as finite-state machines, sequential and combinational logic, and other electronic circuits that can perform the functions necessary for the operation of the current invention. The processing element 68 may be in communication with the other electronic components through serial or parallel links that include address busses, data busses, control lines, and the like.

The safety circuit 70 is configured to disconnect electric power to one or more components of the irrigation system 10. In one or more embodiments, the safety circuit 70 is configured to disconnect electric power to one or more of the motors 56, 58, 60, 62 and/or the pump 34. The safety circuit 70 may comprise one or more circuit breakers, transistors, relays, or the like.

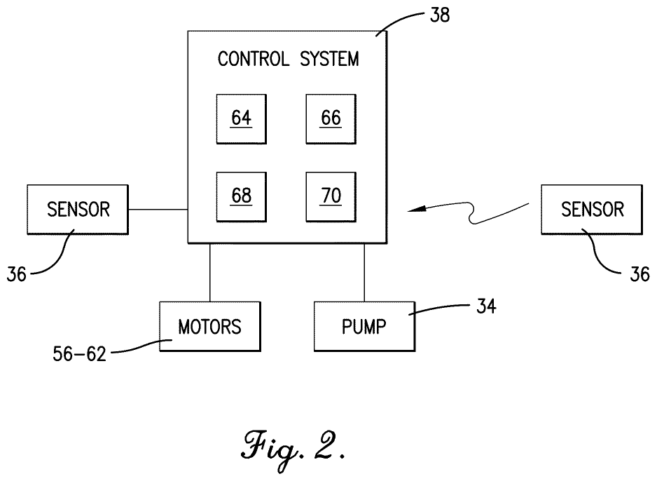

The processing element 68 of the control system 38 may be in communication with one or more of the pumps 34, one or more of the sensors 36, and/or one or more of the motors 56, 58, 60, 62, as depicted in FIG. 2. The processing element 68 may be in communication with the above components via the communication element and/or direct wiring. The processing element of the control system 38 may be configured to send and/or receive information to and/or from the above components. The processing element of the control system 38 may also be configured to send and/or receive command to and/or from the above components.

The processing element 68 of the control system 38 may be configured to transmit a command signal to one or more of the motors 56, 58, 60, 62 of the irrigation system 10. In one or more embodiments, the command signal has a duty cycle with an active portion and an inactive portion. The active portion may be a binary signal that represents an instruction for one or more of the motors 56, 58, 60, 62 to operate. The inactive portion may similarly be a binary signal and/or lack of positive signal/voltage that represents an instruction for one or more of the motors 56, 58, 60, 62 to not operation. In preferred embodiments, the command signal is transmitted to the end motor 56 of the center pivot irrigation system 10, which sets the pace (under ideal conditions and when operating correctly) for the rest of the irrigation system 10.

The processing element 68 of the control system 38 may be configured to receive from the sensor 36 a first signal representative of a first measurement of a characteristic related to power usage of the irrigation system 10. For example, the measurement may be the total current amperage load of the center pivot irrigation system 10, including the motors 56, 58, 60, 62 and the pump 34. In one or more preferred embodiments, the measurement is taken and/or received during one or more active portion of the duty cycle of the command signal sent to the end motor 56.

The processing element 68 of the control system 38 may be configured to receive from the sensor 36 a second signal representative of a second measurement of a characteristic related to power usage of the irrigation system 10. For example, the second measurement may be the total current amperage load of the center pivot irrigation system 10 during one or more inactive portion of the duty cycle of the command signal.

The processing element 68 of the control system 38 may be configured to compare the measurements to infer a status of the irrigation system 10. For example, in one or more embodiment, the processing element 68 is configured to calculate a difference between the first measurement and the second measurement. In one or more embodiment, the difference is compared to a predefined threshold. In one or more embodiments, the predefined threshold may be preconfigured to account for certain tolerances. For example, for measurements of amperage, the predefined threshold may be a percentage of the maximum expected current load. Alternatively, the predefine threshold may be a predefined number of amps. The predefined threshold may also be adjustable by the user through the interface.

For example, as shown in scenario 1 of Table 1, if the difference in amperage is below the predefined threshold, then one scenario this would indicate is that the there is no current draw, the end tower 16 is cycling on and off, and the pivot irrigation system 10 is not moving. Another scenario where the difference is below the predefined threshold, is when the current load is relatively constant but above zero. This would indicate that the motor 56 of the end tower 16 is remaining on, but the pivot is not moving because the other motors 58, 60, 62 are not turning on. In one or more embodiments, the predefined threshold is determined using a machine learning algorithm. For example, a training dataset comprising current draw data and confirmed determinations of irrigation system status may be used to train a neural network implemented by the control system 38.

In one or more embodiments, the processing element 68 may also be configured to determine whether one or more of the measurements are below another predefined threshold. For example, the processing element 68 may be configured to determine whether the second measurement is below a second predefined threshold. For example, as shown in scenario 6 of Table 1, if the amperage as measured during an inactive portion of the command signal is below the second predefined threshold or around zero, then this could indicate that the last tower is cycling on and off and possibly not moving. In such a scenario, in one or more embodiments, the processing element 68 is configured receive from the sensor 36 one or more additional signal representative of an additional measurement of the total power usage, such as the current amperage of the center pivot irrigation system 10. In one or more embodiments, the additional measurement is taken and received during an inactive portion of one or more additional consecutive duty cycle of the command signal. In one or more embodiments, if the additional measurement is below a predefined threshold, such as an amperage measurement of around zero, then this confirms that the end tower 16 is cycling on and off, and the irrigation system 10 is not moving. In one or more embodiments, the second predefined threshold may also be determined using machine learning.

TABLE 1

| Scenario | Amperage Average | Indication | Therefore | Amperage |
|---|---|---|---|---|
| 1 | Amperage is zero for more than 60 seconds | Last tower is not | Pivot is not moving | Zero |
| | | cycling ON/OFF | | |
| 2 | Amperage is at the full motor load amount for the | Boost pump is | Pivot is not moving | Constant |
| | boost pump and the amperage amount has not | ON + Last | | |
| | changed during and immediately after the % duty | tower is NOT | | |
| | cycle ON period | cycling ON/OFF | | |
| 3 | Amperage is at the full motor load amount for the | Boost pump is | Pivot is not moving and last | Constant |
| | boost pump plus one of the tower drive motors for | ON + Last tower | tower motor is also stuck | |
| | more than 60 seconds | is ON constantly | ON or commanded at 100% | |
| 4 | Amperage is greater than the full load motor | Boost pump is OFF + | Pivot is moving normally | Varying |
| | amount for the tower drive motors during and | multiple tower | | |
| | immediately after the % duty cycle ON period | drive motors are ON | | |
| 5 | Amperage is greater than the full motor load for | Boost pump is ON + | Pivot is moving normally | Varying at an |
| | the boost pump plus one of the tower drive | multiple tower | | amount greater than |
| | motors during and immediately after the % duty | drive motors are ON | | the Boost pump |
| | cycle ON period | | | motor full load |
| 6 | Amperage is greater than the full load motor | Last Tower is | Indeterminant - must wait | Varying at an |
| | amount for the tower drive motor during the % | cycling ON/OFF | and see - This wait and see | amount equal to |
| | duty cyde ON period and then drops to zero after | | time period is a function | a single tower |
| | the duty cycle period | | of % speed duty cycle | drive motor |

In one or more embodiments, the sensor 36 may be configured to sample the measurements of the electrical characteristics and/or continuously measure the electrical characteristics. Similarly, the processing element 68 may be configured to sample the measurements or signal from the sensor 36 and/or continuously store the measurements on the memory element 66. The processing element 68 may also be configured to periodically compare the measurements and/or continuously compare one or more of the measurements.

In one or more embodiments, the processing element 68 is configured to send one or more signal in response to one or more of the measurements and/or comparisons of those measurements. In one or more embodiments, the processing element 68 is configured to send to the safety circuit 70 a signal representative of an instruction to disconnect power to the center pivot irrigation system 10 and/or the end motor 56 if the difference between the measurements is below the predefined threshold and/or if one or more of the additional measurements of current draw during an inactive period of the command signal are below the corresponding predefined threshold.

### Computer-Implemented Method Embodiment

The flow chart of FIG. 3 depicts the steps of an exemplary method 300 of controlling operations of an irrigation system. In some alternative implementations, the functions noted in the various blocks may occur out of the order depicted in FIG. 3. For example, two blocks shown in succession in FIG. 3 may in fact be executed substantially concurrently, or the blocks may sometimes be executed in the reverse order depending upon the functionality involved. In addition, some steps may be optional.

The method 300 is described below, for ease of reference, as being executed by exemplary devices and components introduced with the embodiments illustrated in FIGS. 1 and 2. The steps of the method 300 may be performed by the control system 38 through the utilization of processors, transceivers, hardware, software, firmware, or combinations thereof. However, some of such actions may be distributed differently among such devices or other devices without departing from the spirit of the present invention. Control of the system may also be partially implemented with computer programs stored on one or more computer-readable medium(s). The computer-readable medium(s) may include one or more executable programs stored thereon, wherein the program(s) instruct one or more processing elements to perform all or certain of the steps outlined herein. The program(s) stored on the computer-readable medium(s) may instruct processing element(s) to perform additional, fewer, or alternative actions, including those discussed elsewhere herein.

Referring to step 302, the method 300 may include receiving, via one or more processor of the controller of the center pivot irrigation system, a first signal representative of a first measurement of an electrical characteristic related to a current total electrical power usage of the center pivot irrigation system during an active portion of a first duty cycle of a command signal directed to an end tower of the center pivot irrigation system. This step may include transmitting, via the processor, a command signal to one or more of the motors of the irrigation system. As discussed above, in one or more embodiments, the command signal has a duty cycle with an active portion and an inactive portion. The active portion may be a binary signal that represents an instruction for one or more of the motors to operate. The inactive portion may similarly be a binary signal and/or lack of positive signal/voltage that represents an instruction for one or more of the motors to not operation. In preferred embodiments, the command signal is transmitted to the end motor of the center pivot irrigation system, which sets the pace (under ideal conditions and when operating correctly) for the rest of the irrigation system.

This step may include measuring, via the sensor, the electrical characteristic. In one or more embodiments, the measurement is the total current amperage load of the center pivot irrigation system, including the motors and the pump. In one or more preferred embodiments, the measurement is taken and/or received during one or more active portion of the duty cycle of the command signal sent to the end motor. The measurement may be continuously taken or may be a sample taken periodically according to a predefined frequency.

Referring to step 304, the method 300 may include receiving, via the one or more processor of the controller of the center pivot irrigation system, a second signal representative of a second measurement of an electrical characteristic related to a current total electrical power usage of the center pivot irrigation system during an inactive portion of the duty cycle of the command signal directed to the end tower of the center pivot irrigation system. The measurement may be taken during the inactive portion of the same duty cycle or one or more inactive portions of consecutive duty cycles. The measurement may be continuously taken or may be a sample taken periodically according to a predefined frequency.

Referring to step 306, the method 300 may include calculating, via the one or more processor of the controller of the center pivot irrigation system, a difference between the first measurement and the second measurement. This step 306 may include any number of comparison analytics, such as calculating a ratio between the two measurements, or the like, without departing from the scope of the present invention.

Referring to step 308, the method 300 may include determining, via the one or more processor of the controller of the center pivot irrigation system, whether the difference is below a first predefined threshold. As discussed elsewhere herein, in one or more embodiment, the difference is compared to a predefined threshold. The predefined threshold may be preconfigured to account for certain tolerances. For example, for measurements of amperage, the predefined threshold may be a percentage of the maximum expected current load. Alternatively, the predefine threshold may be a predefined number of amps. The predefined threshold may also be adjustable by the user through the interface. If the difference is above the predefined threshold, then the method 300 may proceed to step 310. If the difference is below the predefined threshold, then the irrigation system is likely malfunctioning, and the method may proceed to step 316.

Referring to step 310, the method 300 may include determining, via the processor, whether one or more of the measurements are below another predefined threshold. For example, this step may include determining, via the processor, whether the second measurement is below a second predefined threshold. For example, if the amperage as measured during an inactive portion of the command signal is below the second predefined threshold (or around zero), then this could indicate that the last tower is cycling on and off and possibly not moving. Thus, if the measurement is below the second predefined threshold, then the method 300 may proceed to step 312. In one or more embodiments, if the measurement is above the second predefined threshold, then this would indicate that the irrigation system is properly functioning and the method 300 may therefore include repeating steps 302, 304, 306, 308.

Referring to step 312, the method 300 may include receiving, via the processor, from the sensor one or more additional signals representative of an additional measurement of the total power usage, such as the current amperage of the center pivot irrigation system. In one or more embodiments, the additional measurement is taken and received during an inactive portion of one or more additional consecutive duty cycle of the command signal.

Referring to step 314, the method 300 may include determining, via the processor, whether the additional measurement is below the second predefined threshold. If the measurement is below the second predefined threshold, then there is likely a malfunction with the irrigation system, and the method 300 may proceed to step 316. In one or more embodiments, if the measurement is above the second predefined threshold, then this would indicate that the irrigation system is likely functioning properly and the method 300 may therefore include repeating steps 302, 304, 306, 308, 310, 312.

Referring to step 316, the method 300 may include sending, via the one or more processor of the controller of the center pivot irrigation system, a signal representative of an instruction to disconnect power from the end tower of the center pivot irrigation system. This step may further include sending, via the processor, one or more signal to disconnect power to one or more other components of the irrigation system, including one or more pump and/or one or more valve. The signal may be sent to the safety circuit for disconnecting the relevant component. This step may also include sending, via the one or more processor of the controller of the center pivot irrigation system, a signal representative of an instruction to wirelessly transmit a notification to a remote user device. This step may include transmitting, via the communication element, one or more wireless signal representative of a notification to a remote user device. This step may include transmitting, via the communication element, one or more wired signal representative of a notification to a user interface of the irrigation system, such as the control panel of the irrigation system. The notification may be an indication of a fault, error, or the like.

The method 300 may include additional, less, or alternate steps and/or device(s), including those discussed elsewhere herein.

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A method of determining if a mechanized irrigation system has stopped moving, the method comprising:
receiving a first signal representative of a first measurement of an electrical characteristic related to a current total electrical power usage of the mechanized irrigation system;
receiving a second signal representative of a second measurement of an electrical characteristic related to a current total electrical power usage of the mechanized irrigation system;
calculating a difference between the first measurement and the second measurement;
determining whether the difference is below a first predefined threshold; and
performing one or more predefined action(s) if the difference is below the first predefined threshold.

2. The computer-implemented method of claim 1, further comprising receiving one or more signals representative of instructions to adjust the first predefined threshold, the one or more signals being received from at least one of a user interface of the mechanized irrigation system or a remote device.

3. The method of claim 1, wherein the electrical characteristic is an electric current.

4. The method of claim 1, wherein the current total electrical power usage includes electrical power consumed by one or more pump of the center pivot irrigation system.

5. The method of claim 4, wherein the current total electrical power usage includes electrical power consumed by two or more motors of the center pivot irrigation system.

6. The computer-implemented method of claim 1, wherein the predefined action(s) comprises at least one of:
sending, via the one or more processor of the controller of the center pivot irrigation system, a signal representative of an instruction to disconnect power from all towers of the center pivot irrigation system if the difference is below the predefined threshold,
sending, via the one or more processor of the controller of the center pivot irrigation system, a signal representative of an instruction to close one or more valve to the center pivot irrigation system,
sending, via the one or more processor of the controller of the center pivot irrigation system, a signal representative of an instruction to wirelessly transmit a notification to a remote user device,
sending, via the one or more processor of the controller of the center pivot irrigation system, a signal representative of an instruction to wirelessly transmit a fault indication to a remote user device, or
sending, via the one or more processor of the controller of the center pivot irrigation system, a signal representative of an instruction to display a notification on a user interface of a control panel of the center pivot irrigation system.

7. The method of claim 1, further comprising automatically adjusting the first predefined threshold based upon historical data of the first and second measurements.

8. The computer-implemented method of claim 1, wherein the total electrical power usage includes only a single phase of a multiple-phase system.

9. The method of claim 1, wherein the electrical characteristic is an electric current.

10. A center pivot irrigation system comprising:
a plurality of mobile support towers configured to move across a field about a central pivot point, the plurality of mobile support towers including a radially outmost mobile support tower having an end motor and one or more inner mobile support towers located radially inward from the radially outmost mobile support tower and having one or more inner motor;
a fluid-carrying conduit supported above the field by the plurality of mobile support towers;
fluid emitters coupled with the fluid-carrying conduit;
one or more pump for directing flow of fluids through the fluid emitters; and
one or more processor in communication with the end motor, the one or more inner motor, and the one or more pump, the one or more processor configured to:
transmit a command signal having a duty cycle with one or more active portion and one or more inactive portion to the end motor;
receive one or more signals representative of one or more measurements of an electrical characteristic related to a current total electrical power usage of the end motor, the one or more inner motor, and the one or more pump during at least one of the one or more active portions or the one or more inactive portions of the duty cycle of the command signal;
determine whether the plurality of mobile towers have moved across the field; and
perform one or more predefined action(s) if the plurality of mobile towers have not moved across the field.

11. The irrigation system of claim 10, further comprising one or more user interface in communication with the one or more processor, wherein the one or more processor is configured to send a signal representative of an instruction to display a fault indication.

12. The irrigation system of claim 10, further comprising one or more communication element in communication with the one or more processor, wherein the one or more processor is configured to send a signal representative of an instruction to transmit a wireless signal representative of a fault indication.

13. The irrigation system of claim 10, wherein the one or more processor is configured to:
determine whether one or more second measurements are below a second predefined threshold;
receive one or more additional signals representative of one or more additional measurements of the electrical characteristic related to the current total electrical power usage during at least one of the one or more active portions or the one or more inactive portions of the duty cycle of the command signal; and
send a signal representative of an instruction to disconnect power from the end motor if the one or more additional measurements are below the second predefined threshold.

14. The irrigation system of claim 10, wherein the electrical characteristic is an electric current, and the current total electrical power usage includes electrical power consumed by the end motor, the one or more pump, and the one or more inner motor.

15. The irrigation system of claim 10, wherein the one or more processor is configured to send a signal representative of an instruction to disconnect power from the one or more pump and the one or more inner motor if the difference is below the first predefined threshold.

16. The irrigation system of claim 10, wherein the one or more processor is configured to send a signal representative of an instruction to close one or more valve to the center pivot irrigation system.

17. The irrigation system of claim 10, wherein the total electrical power usage includes only a single phase of a three-phase system.

18. A controller for controlling operations of a center pivot irrigation system in a field having mobile support towers configured to move across the field about a central pivot point, the mobile support towers including a radially outmost mobile support tower having an end motor and one or more inner mobile support towers located radially inward from the radially outmost mobile support tower and having one or more inner motor, the controller comprising:
one or more safety circuit configured to disconnect electric power to the center pivot irrigation system;
one or more sensor configured to detect a total current amperage of the center pivot irrigation system; and
one or more processor in communication with the one or more safety circuit and the one or more sensor, the one or more processor configured to:
transmit a command signal having a duty cycle with an active portion and an inactive portion to the end motor of the center pivot irrigation system;
receive from the one or more sensor a first signal representative of a first measurement of the total current amperage of the center pivot irrigation system;
receive from the one or more sensor a second signal representative of a second measurement of the total current amperage of the center pivot irrigation system;
calculate a difference between the first measurement and the second measurement;
determine whether the difference is below a first predefined threshold;
send to the one or more safety circuit a signal representative of an instruction to disconnect power to the center pivot irrigation system if the difference is below the first predefined threshold;
determine whether the second measurement is below a second predefined threshold;
receive from the one or more sensor an additional signal representative of an additional measurement of the total current amperage of the center pivot irrigation system during one or more additional consecutive duty cycle of the command signal; and
send to the one or more safety circuit a signal representative of an instruction to disconnect power to the center pivot irrigation system if the additional measurement is below the second predefined threshold.

19. The controller of claim 18, wherein the one or more processor is configured to receive one or more signals representative of instructions to adjust the first predefined threshold, the one or more signals being received from at least one of a user interface of the center pivot irrigation system or a remote device.

20. The controller of claim 18, wherein the one or more processor is configured to automatically adjust the first predefined threshold based upon historical data of the first and second measurements.
